(19) United States
(12) Patent Application Publication
(10) Pub. No.: US 2014/0249750 A1
(43) Pub. Date: Sep. 4, 2014

(54) NAVIGATIONAL AND LOCATION DETERMINATION SYSTEM

(71) Applicant: John Hamilton, Solsberry, IN (US)

(72) Inventor: John Hamilton, Solsberry, IN (US)

(21) Appl. No.: 14/053,974

(22) Filed: Oct. 15, 2013

Related U.S. Application Data
(60) Provisional application No. 61/713,695, filed on Oct. 15, 2012.

(51) Int. Cl. G01C 21/16

(52) U.S. Cl. CPC G01C 21/165
USPC 701/469

(57) ABSTRACT

A navigation and location system including an inertial navigation unit, a global positioning system, a control system, and a machine readable recording medium storing a plurality of non-transitory machine readable instructions adapted to determine a desired orientation of a sensor at a desired point with respect to the Earth based on determination of orientation of a reference axis of a sensor with respect to locations of multiple points and relationships between the multiple points with a significant degree of accuracy using non-magnetic directional sensing, orientation sensing comprising position determinations via the GPS, orientation data acquired from said inertial navigation unit, and a sequence of measurements along a displaced path including said position determinations and said orientation data. An additional embodiment can include a remote sensing system for remote sensing of an object of interest.

### CROSS-REFERENCE TO RELATED APPLICATIONS

The present application claims priority to U.S. Provisional Patent Application Ser. No. 61/713,695, filed Oct. 15, 2012, entitled “GPS/IMU BASED NON-MAGNETIC NORTH SEEKER,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon.

### BACKGROUND AND SUMMARY OF THE INVENTION

The present invention addresses a need to quickly find an accurate heading of a hand carried device without the need for magnetic field measurement. Portable systems capable of being carried by humans in a typical application desired by persons moving across country based on non-magnetic north (or south) seeking systems are not available due to a variety of limiting factors including size, weight, and power. Accordingly, in simplified terms, an invention has been created to provide a needed capability to determine a desired orientation of a sensor at a desired point with respect to the Earth (e.g., true north) based on determination of orientation of a reference axis of a sensor with respect to locations of multiple points and relationships between the multiple points with a significant degree of accuracy using non-magnetic directional sensing, orientation sensing, determinations via global positioning satellites (GPS), and a sequence of measurements along a displaced path. Location can include elevation of the sensor at each point of measurement which can be used in an embodiment. A desired orientation of the sensor at a desired point can include the first point at which a suitably accurate orientation, e.g., true north, can be determined e.g., less than five mil degrees accuracy (e.g., an angular mill can be found by dividing 360 degrees by 6000). A sequence of measurements can include at least two measurements in accordance with an embodiment the invention along a path of travel which is, for example, not purely vertical in elevation. An embodiment of the non-magnetic directional sensing, navigational and orientation system can include an inertial navigation system coupled with a GPS system along with a control system adapted for executing a series of computations and generating results in accordance with an embodiment of the invention. Accordingly, multiple measurements and determinations can be made until a predetermined orientation accuracy value has been found to be achieved.

For example, an embodiment can provide a solution to meet unmet needs that includes, for simplification purposes, two parts. A first general part includes deriving a series of accurate location, elevation, and heading determinations via GPS. A second part includes accurately capturing an orientation of a sensing device in accordance with an embodiment of the invention and thus a direction that the non-magnetic sensor is pointing or orientated. An embodiment of the invention also includes a system adapted to execute the above parts in a variety of sequences to determine required information that is in turn used to identify with significant precision a needed geodetic or Earth fixed orientation.

An additional embodiment also is adapted to remote sensing of a specific location of a location of interest or object based on a combination of current navigation location/orientation and remote sensing of distance/orientation to the location/object of interest. For example, an embodiment of the invention can provide a remote sensing/determination of position of an object/location of interest based on the non-magnetic based location/navigation/orientation determination capability. An example of remote sensing embodiments can include addition of a laser range finder in addition to an additional set of computations in a control system in accordance with an embodiment of the invention. An exemplary embodiment can determine remotely coordinates of an object of interest/object using such an embodiment.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

The detailed description of the drawings particularly refers to the accompanying figures in which:

FIG. 1 is a graph showing resulting heading error as a function of a sampling displacement which is useful in an embodiment of the invention in creating a result having a predetermined degree of non-magnetic direction sensing accuracy;

FIG. 2 shows a graph illustrating how heading accuracy is path independent but GPS accuracy dependent which is useful in an embodiment of the invention in creating a result having a predetermined degree of non-magnetic direction sensing accuracy;

FIG. 3 shows a simplified direction traveled in a two dimensional grid reference dependent which is useful in an embodiment of the invention in creating a result having a predetermined degree of non-magnetic direction sensing accuracy;

FIG. 4 shows an exemplary embodiment's generation of a simulated gyroscopic drift assuming GPS calibration with no zero velocity updates at 1 m/s dependent which is useful in an embodiment of the invention in creating a result having a predetermined degree of non-magnetic direction sensing accuracy;

FIG. 5 shows a simulated gyroscopic drift assuming GPS calibration with zero velocity updates for 25% of the time at 1 m/s dependent which is useful in an embodiment of the invention in creating a result having a predetermined degree of non-magnetic direction sensing accuracy;

FIG. 6 shows a block diagram of system components in accordance with one embodiment of the invention;

FIG. 7 shows machine readable instructions organized by software code modules in accordance with an embodiment of the invention;

FIG. 8A shows a flow chart for performing processing according to one embodiment of the invention;

FIG. 8B shows a continuation of the FIG. 8A flow chart for performing processing according to another embodiment of the invention;

FIG. 9 shows a navigation display in accordance with one embodiment of the invention;

FIG. 10 shows a navigation display device with laser range finder in accordance with another embodiment of the invention; and

FIG. 11 shows another exemplary embodiment display including a minimal display with a laser range finder.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

An exemplary invention can determine heading derived from a GPS output by determining location of two collinear points. An accuracy of this heading in this embodiment is related to three variables:
1. An accuracy in determining latitude
2. An accuracy in determining longitude
3. A distance between the two points.

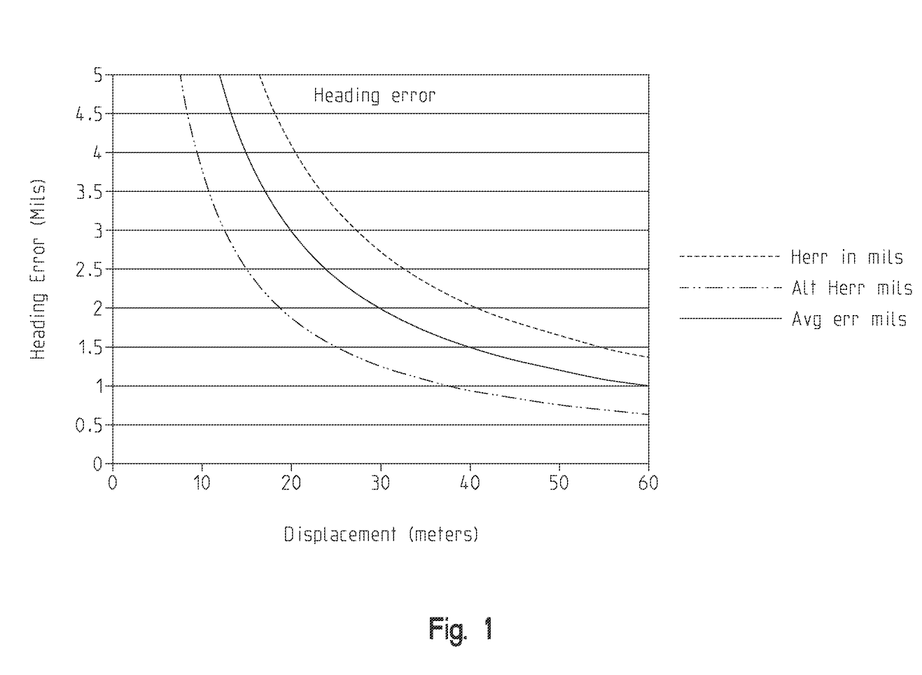

FIG. 1 shows a graph detailing resulting heading error as a function of the sampling displacement in accordance with one embodiment of the invention. An assumption of 1 meter GPS accuracy in real-time is a reasonable assumption based on Real Time Kinematic (RTK) updates and/or differential global positioning system (GPS). Heading error (Hₑᵣᵣ) in mils was derived using Equation 7, Alternate Heading error (Alt Hₑᵣᵣ) mils was derived using Equation 8. Avg err mils is the average of the two methods. Alternate heading error can be based on data that GPS devices calculate their position in an Earth Centered, Earth Fixed (ECEF) frame and that the error associated with this frame is comparable to the error associated with a latitude and longitude measurement.

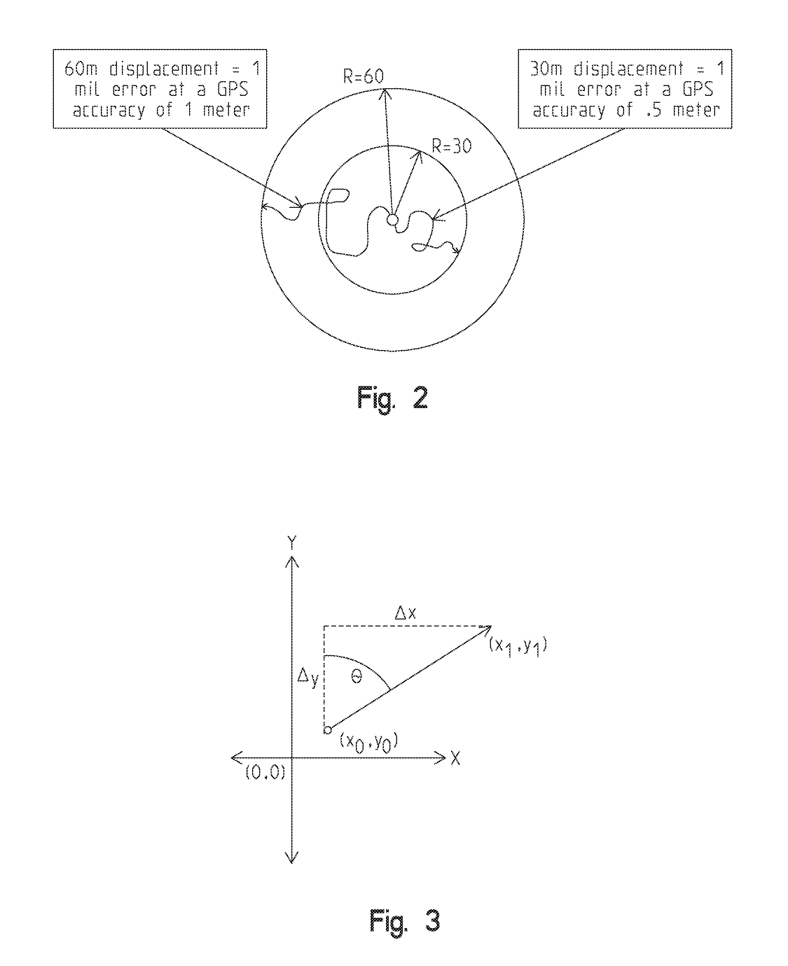

In accordance with an embodiment of the invention, displacement discussed in FIG. 1 and shown in FIG. 2 can be any direction and is independent of the path taken. FIG. 2 shows a graph illustrating how heading accuracy is path independent but GPS accuracy dependent in accordance with an embodiment of the invention. Accuracy of heading measured via displacement can be dependent upon accuracy of a GPS. The squiggly line in FIG. 2 shows independence of path taken where, in this embodiment, only a total horizontal straight path distance is displaced (e.g., horizontal displacement is used in calculations to determine orientation and heading). In accordance with one embodiment of the invention, the following equations and FIG. 3 can be used to determine a heading traveled by a non-magnetic compass from GPS data.

FIG. 3 shows a simplified direction traveled in a two dimensional grid reference in accordance with an embodiment of the invention. Referring to FIG. 3, the (x0,y0) and (x1,y1) positions are measured via a GPS device, after which positions in a local level Cartesian (LLC) plane are calculated. The LLC is based on the assumption that the earth is locally flat on the scale that is being measured. The curvature of the earth is 0.013 cm/km, so for displacements of 200 meters or less a LLC assumption or approximation is valid.

In one embodiment of the invention, to convert Δlat to Δy & Δlon to Δx in LLC the below formulas can be used. A midpoint between two latitude or longitude points are labeled ML and equals the latitude/longitude midway between x0,y0 & x0,y1 as in equation 1 (note all latitude and longitude measurements are in degree decimal notations).

$$\{ \begin{matrix}MLat = \frac{{lat}_{0} + lat 1}{2} \\ MLon = \frac{{lon}_{0} + {lon}_{1}}{2}\end{matrix} \qquad Equation 1$$

Next the change in latitude and longitude are converted to a change in meters. This is done by finding the number of meters per degree of latitude and longitude (MDL). MDL are found with the following equations (note cos(x) is the degree cos and not radian cos):

$$\{ \begin{matrix}\begin{matrix}\frac{meters}{° lon} = 1114151.3 * cos ( MLon ) - \\ 945.5 * cos ( 3 MLon ) + 1.2 * cos ( 5 MLon )\end{matrix} \\ \begin{matrix}\frac{meters}{° lat} = 1111320.9 - 5660.5 * \\ cos ( 2 MLat ) + 12.0 * cos ( 4 MLat )\end{matrix}\end{matrix} \qquad Equation 2$$

Then the displacement in North/South (Δy) and East/West (Δx) are calculated using equation 3.

$$\{ \begin{matrix}Δ x = \frac{meters}{° lon} * ( {lon}_{0} - {lon}_{1} ) \\ Δ y = \frac{meters}{° lat} * ( {lat}_{0} - {lat}_{1} )\end{matrix} \qquad Equation 3$$

From FIG. 3 the derivation of the heading angle θ can be derived with the use of the inverse tangent function and calculated using equation 4 (note arctan2 is the 4 quadrant arctangent function).

θ=arctan 2(Δx, Δy) Equation 4

The error associated with the heading angle is then found using equations 5 through 9.

MLₑᵣᵣ=\sqrt{(lat₀^{err})²+(lat₁^{err})²}=\sqrt{(lon₀^{err})²+(lon₁^{err})²} Equation 5

MLₑᵣᵣ is the error term for latitude0±latitude1, longitude0±longitude1, MLat, and MLon.

$$\begin{matrix}\{ \begin{matrix}{\frac{m}{° lon} \vert}_{err} = {ML}_{err} * \sqrt{\begin{matrix}{sin ( ML )}^{2} + 9 {sin ( 3 ML )}^{2} + \\ 25 sin {( 5 ML )}^{2}\end{matrix}} \\ {\frac{m}{° lat} \vert}_{err} = 2 {ML}_{err} * \sqrt{{sin ( 2 ML )}^{2} + 4 {sin ( 4 ML )}^{2}}\end{matrix} & Equation 6 \\ \{ \begin{matrix}Δ {x}_{err} = \sqrt{{( \frac{{\frac{m}{ ° lon} \vert}_{err}}{\frac{m}{° lon}} )}^{2} + {( \frac{{ML}_{err}}{{lon}_{0} - {lon}_{1}} )}^{2}} \\ Δ {y}_{err} = \sqrt{{( \frac{{\frac{m}{° lat} \vert}_{err}}{\frac{m}{ ° lat}} )}^{2} + {( \frac{{ML}_{err}}{{lat}_{0} - {lat}_{1}} )}^{2}}\end{matrix} & Equation 7\end{matrix}$$

Equation 7 could also be modeled with the knowledge that GPS units do all of their calculations in the ECEF frame and that on the scale of 500 meters or less the earth is locally flat. Thus ΔX, ΔY, and ΔZ each depend on the accuracy of the GPS unit being used. This changes equation 7 to look like equation 8. (Note (ΔX,ΔY,ΔZ) refer to the change displacement as measured in ECEF; not the calculated change of (x,y,z) as measured in the LLC.

$$\{ \begin{matrix}Δ {x}_{err} = \sqrt{\frac{{gps\_accuraccy}_{ECEF}}{Δ X}} \\ Δ {y}_{err} = \sqrt{\frac{{gps\_accuraccy}_{ECEF}}{Δ Y}}\end{matrix} \qquad Equation 8$$

Equation 9 then gives the heading uncertainty associated with the straight line heading between two points.

$${θ}_{err} = \sqrt{{( \frac{Δ {x}_{err}}{Δ x} )}^{2} + {( \frac{Δ {y}_{err}}{Δ y} )}^{2}} * \frac{1}{1 + {θ}^{2}} \qquad Equation 9$$

The azimuth angle in equation 4, and the corresponding error in equation 9, are in radians and can be converted to degrees or mils with ease, as shown in equation 10.

$$\{ \begin{matrix}1 mil = \frac{360 °}{6400} = 0.05625 ° \\ 1 mil = \frac{2 π}{6400} = 9.817 e - 4 rad \\ 1 ° = \frac{π}{180} rad\end{matrix} \qquad Equation 10$$

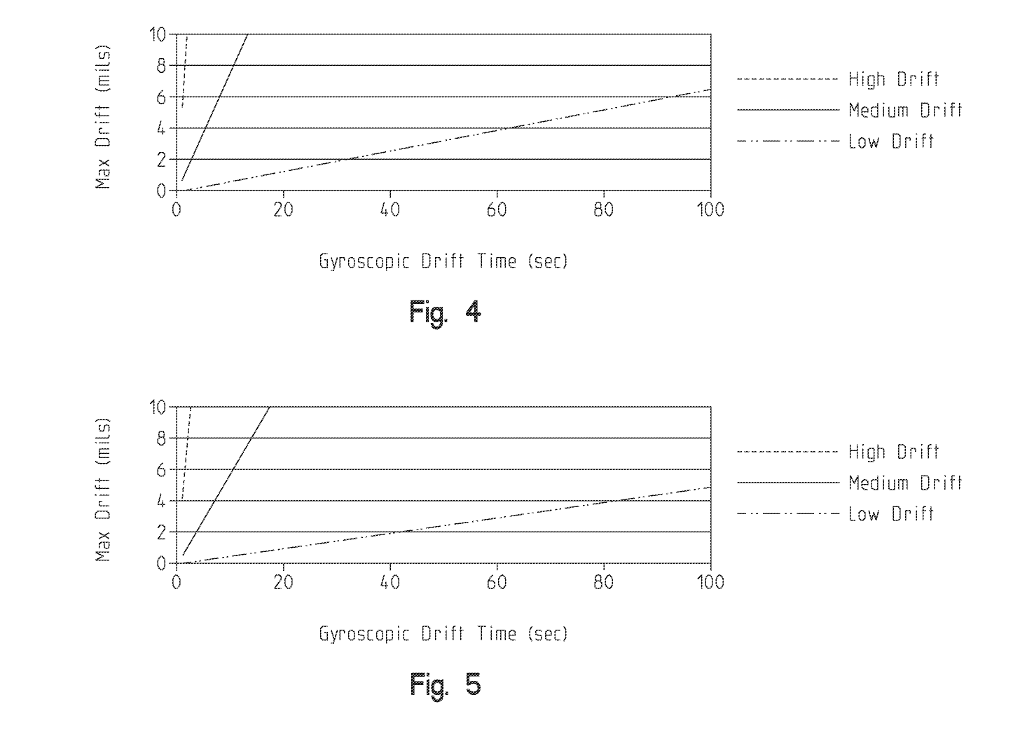

In this embodiment, because the exemplary IMU contains an exemplary integrated GPS, the IMU can self calibrate via GPS and the dominate error in orientation becomes the accuracy of the gyroscopes. In a calibrated IMU the dominate terms in gyroscopic error are Gyroscopic drift and Angular Random Walk (ARW). FIG. 4 and FIG. 5 show results of these drifts on heading accuracy for three grades of gyroscopes. FIG. 4 shows an embodiment where simulated gyroscopic drift assuming GPS calibration with NO zero velocity updates at 1 m/s. FIG. 5 shows an embodiment with a simulated gyroscopic drift assuming GPS calibration with zero velocity updates for 25% of the time at 1 m/s. These exemplary grades are defined by differing levels of inherent gyroscopic drift, defined as: low grade (1088 deg/h), mid grade (152 deg/h), and high grade (13 deg/h). Thus, in an embodiment the total error in heading is the summation of GPS displacement error and Gyroscopic drift error.

In an exemplary embodiment, a second part of one aspect of a problem is discerning a heading of a GPS device once the displacement heading is determined. Determining heading in this context can be done taking into account that an IMU in standalone mode can be a relative navigator, but when coupled with an external source, such as GPS, an exemplary embodiment can becomes an absolute navigator. For the non-magnetic compass this exemplary embodiment can be executed by assembling the IMU and GPS device into a strap down configuration and drawing an imaginary reference line through the device. The exemplary reference line's orientation and acceleration can be then tracked from (x0,y0) to (x1,y1) allowing the device to give a heading relative to the imaginary reference line. Once the exemplary reference line's orientation with respect to devices displacement heading is established in an exemplary embodiment of the invention, future orientation can be tracked with the IMU's orientation sensor or gyroscopes. Thus the exemplary device can automatically track GPS and heading once turned on, with no user intervention.

For example, a user can turn on an exemplary device such that only the z axis of the accelerometer is measuring the acceleration due to gravity. The exemplary imaginary reference line is collinear with the x axis accelerometer and pointed due north. Then, an exemplar system/user can displace the device due East. (Note the Z axis measuring gravity, and the X axis pointing north, and East displacement was picked for ease of discussion. Device can be pointed and displaced any direction.) Since an x-axis accelerometer was pointed north it measures no acceleration and can only be pointed north or south. With the a priori knowledge of the (x,y,z) accelerometers configuration in an exemplary embodiment of the invention, an embodiment can determine that the x-axis and the reference line are both pointed north during the displacement.

For example, an exemplary system having one meter GPS accuracy could include an embodiment where a user travels at a heading of 90° for 60 meters for 60 seconds. An exemplary device can measure 90°±1 mil according to GPS displacement. Then a user, within 3 seconds of stopping, points the device, and the imaginary reference line at an object in the distance. The exemplary device measures the change in orientation from the heading traveled to the direction pointed and returns a compass heading of 23.5°±4.2 mils. The ±4.2 mils is composed of 1 mil error from the displacement and 2.8 mils error from the gyro drifting during the first 60 seconds and 0.14 mils error during the 3 seconds used to acquire a heading sight.

In another exemplary system with an assumption of 0.5 meter GPS accuracy, a user would need to displace 30 meters instead of 60 meters. This would give a heading of 23.5°±2.6 mils. The ±2.6 mils is composed of 1 mil error from the displacement and 1.44 mils error from the gyro drifting during the first 30 seconds and 0.14 mils error during the 3 seconds used to acquire a heading sight.

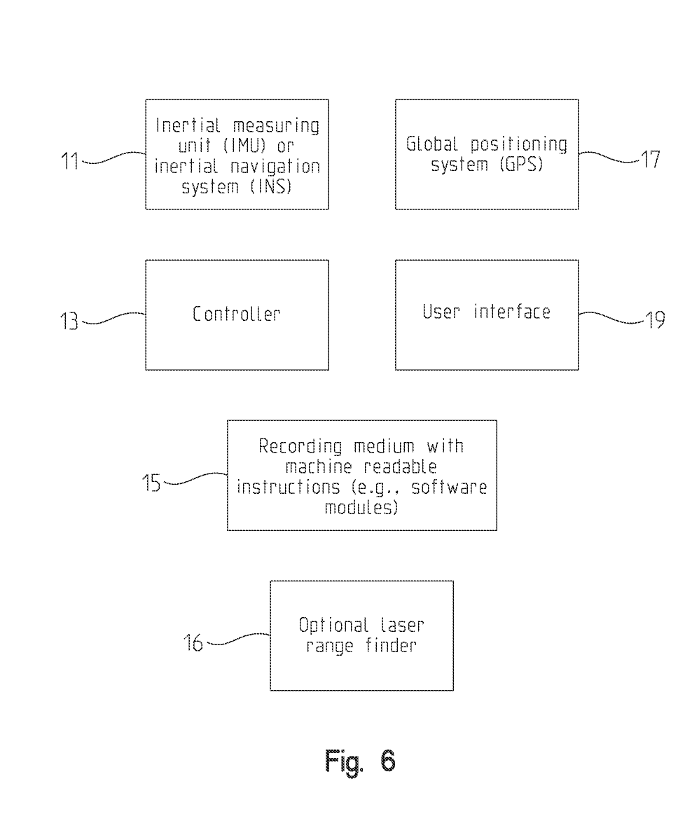

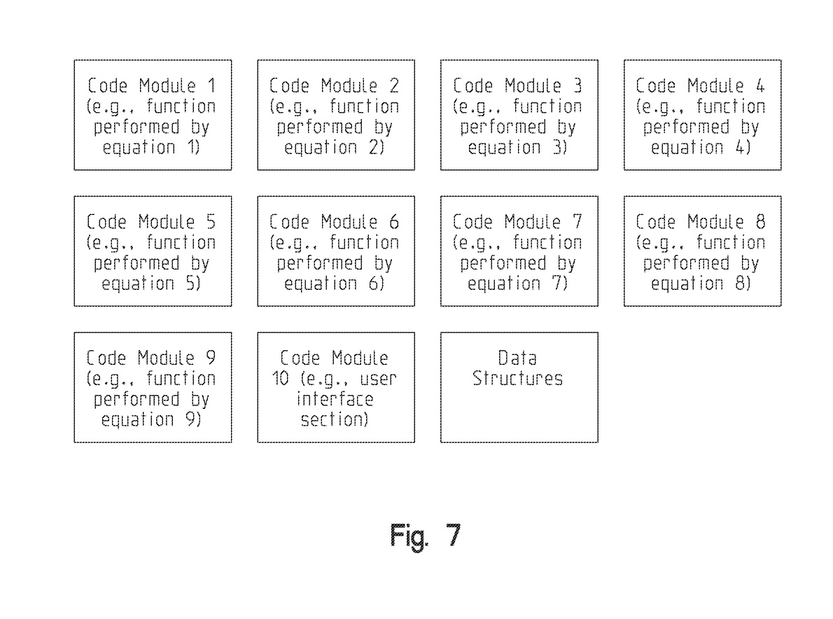

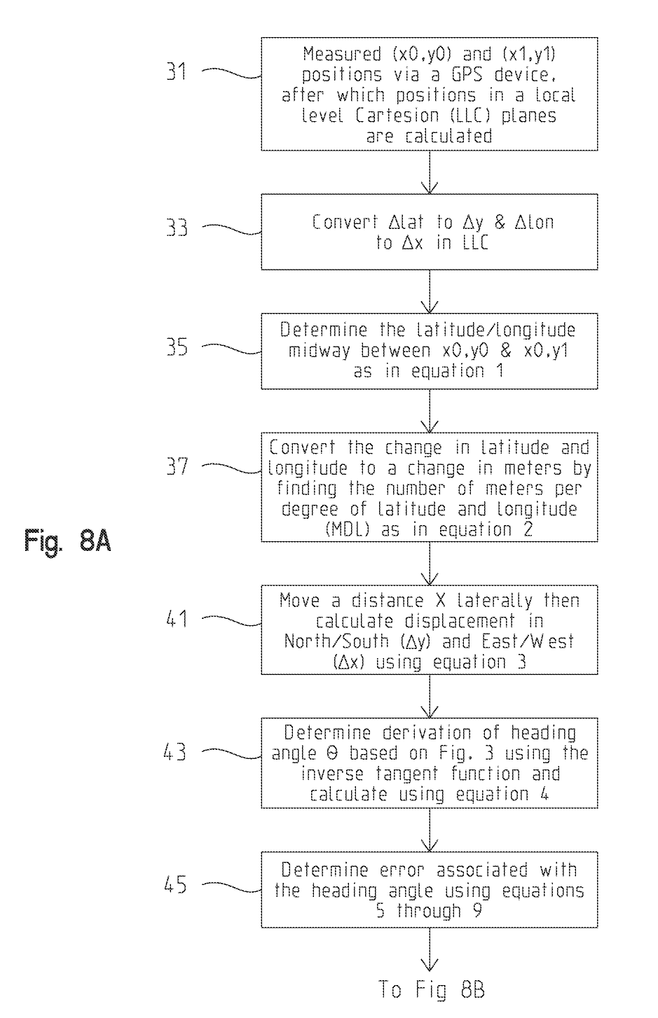

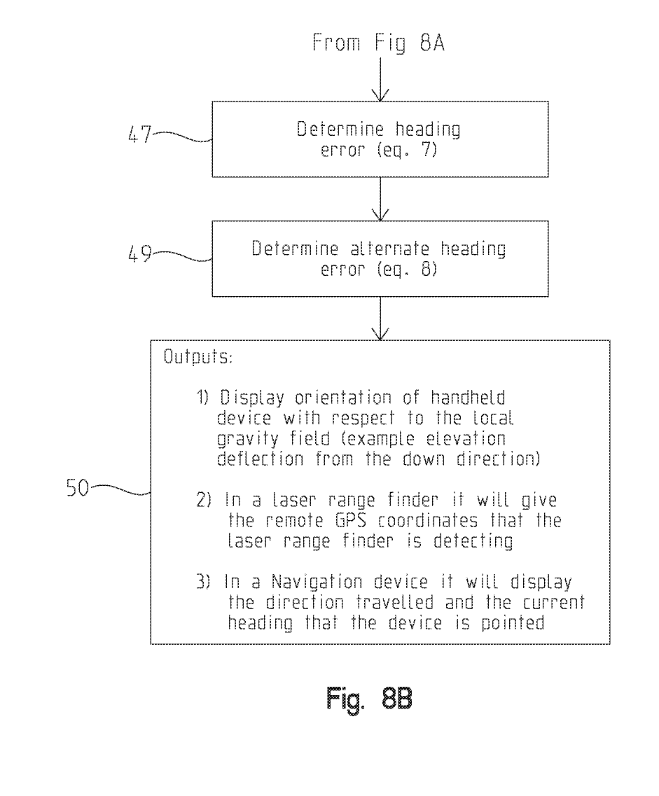

FIG. 6 shows a block diagram of a system in accordance with one embodiment of the invention. An IMU or INS 11, GPS 17, controller 13, user interface 19, and recording medium containing machine readable instructions in accordance with an embodiment of the invention 15 is shown. An alternative embodiment can include a laser range finder which is coupled to the system to perform additional functionality such as discussed herein.

FIG. 7 shows a block diagram of code blocks in accordance with one embodiment of the invention. Machine readable instructions in accordance with an embodiment of the invention can include Code Module 1(e.g., function performed by equation 1), Code Module 2 (e.g., function performed by equation 2), Code Module 3 (e.g., function performed by equation 3), Code Module 4 (e.g., function performed by equation 4), Code Module 5 (e.g., function performed by equation 5), Code Module 6 (e.g., function performed by equation 6), Code Module 7 (e.g., function performed by equation 7), Code Module 8 (e.g., function performed by equation 8), Code Module 9 (e.g., function performed by equation 9), Code Module 10 (e.g., User Interface Section), and Data Structures storing data in accordance with an embodiment of the invention.

FIG. 8A shows a processing sequence in accordance with one embodiment of the invention. Step 31 includes processing including acquiring measured (x0,y0) and (x1,y1) positions via a GPS device, after which positions in a local level Cartesian (LLC) plane are calculated. Step 33 includes processing which includes convert Δlat to Δy & Δlon to Δx in LLC. Step 35 includes processing including determine the latitude/longitude midway between x0,y0 & x0,y1 as in equation 1. Step 37 includes processing including convert the change in latitude and longitude to a change in meters by finding the number of meters per degree of latitude and longitude (MDL) as in Equation 2. Step 41 includes processing including move a distance X laterally then calculate displacement in North/South (Δy) and East/West (Δx) using equation 3. Step 43 includes processing including determine derivation of heading angle θ based on FIG. 3 using the inverse tangent function and calculate using equation 4. Step 45 includes processing including determine error associated with the heading angle using equations 5 through 9. Step 47 includes processing including determine heading error (Equation 7). Step 49 includes processing including determine alternate heading error (Equation 8).

Referring to FIG. 8B, shows another embodiment of the invention to include output following processing in accordance with one embodiment of the invention, such as shown in FIG. 8A. Several outputs 50 are shown including a display orientation of handheld device with respect to true north and angle of elevation with respect to a local gravity field (example elevation deflection from the down direction). Another exemplary output can include a system having a laser range finder that can provide remote GPS coordinates that the laser range finder is detecting. Another exemplary embodiment output can include a navigation device that can display a direction travelled and a current heading that a sensor device is pointed.

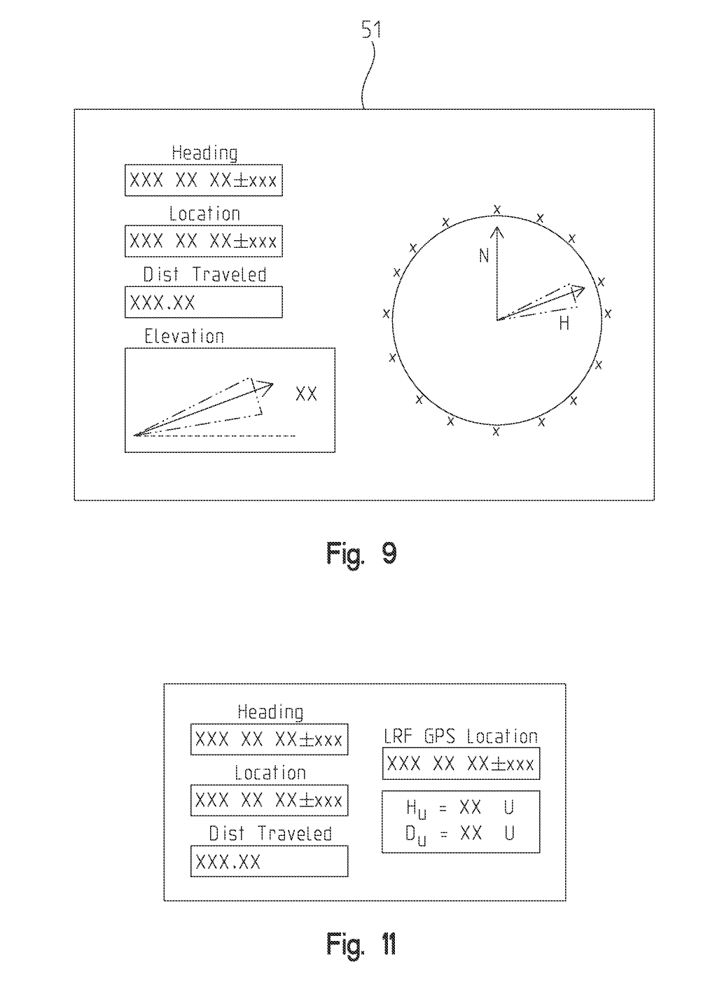

FIG. 9 shows a navigation display in accordance with one embodiment of the invention. An exemplary display includes a Digital Display of Heading of Device Orientation in Degrees, Minutes, Seconds, or Degrees Decimal±Current uncertainty in heading/orientation. The exemplary display also Current GPS location in In Degrees, Minutes, Seconds, or Degrees Decimal±Current uncertainty in location. Distance traveled+units is also shown. An exemplary display also includes a symbol representing the elevation orientation with respect to local gravity field or the down direction. Shading represents uncertainty in elevation. XX=Digital display of elevation 0°=Flat 90°=straight up. Compass style representation of Heading/Orientation as well as N=True North, H=Heading/Orientation, Little ‘x’=Degrees on the compass, and Shaded triangle=Uncertainty in heading.

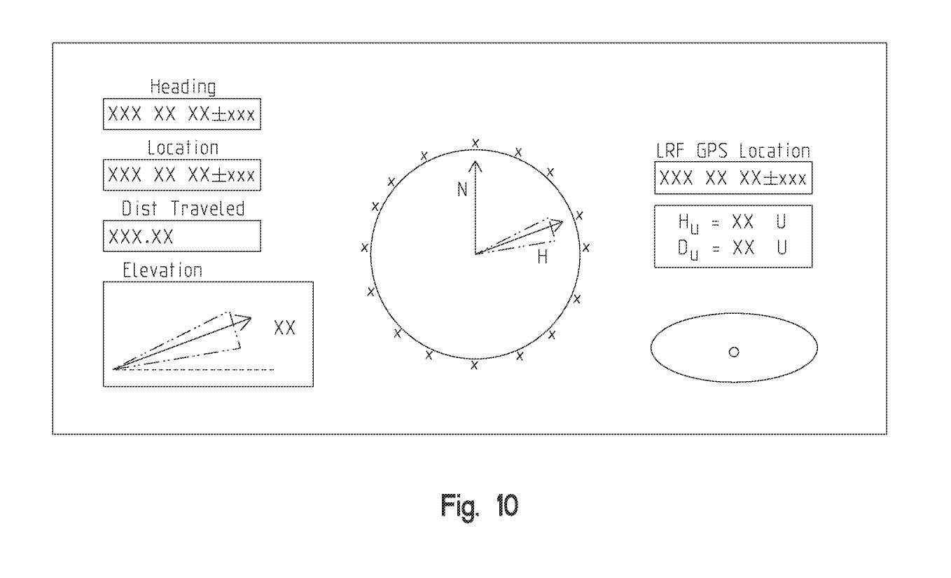

FIG. 10 shows a navigation display device with laser range finder in accordance with another embodiment of the invention. An exemplary embodiment includes Digital Display of Heading of Device Orientation In Degrees, Minutes, Seconds, or Degrees Decimal±Current uncertainty in heading/orientation. The exemplary embodiment display also includes Current GPS location in In Degrees, Minutes, Seconds, or Degrees Decimal±Current uncertainty in location. Distance traveled+units is also shown. An exemplary embodiment also includes symbol which can represent elevation orientation with respect to local gravity field or the down direction. Shading represents uncertainty in elevation. XX=Digital display of elevation 0°=Flat 90°=straight up. An exemplary display also can include a compass style representation of Heading/Orientation, N=True North, H=Heading/Orientation, Little ‘x’=Degrees on the compass, and Shaded triangle=Uncertainty in heading. An exemplary display also includes LRF=Laser Ranger Finder and LRF GPS Location refers to the GPS coordinates of a target that LRF is being used on. An exemplary embodiment display includes Hu as horizontal uncertainty in the LRF GPS, Location with ‘U’ being the units that ‘XX’ is being measured in, and Du is the down range uncertainty in the LRF GPS Location with ‘U’ being the units that ‘XX’ is being measured in. an exemplary embodiment can also include Graphical representation of Hu and Du. An exemplary embodiment can include a black dot at center equals that the LRF GPS Location.

FIG. 11 shows another exemplary embodiment display including a minimal display with a laser range finder. An exemplary embodiment can include a Digital Display of Heading of Device Orientation, Current GPS location in Degrees, Minutes, Seconds, or Degrees Decimal±Current uncertainty in location. An exemplary display can show results in Degrees, Minutes, Seconds, or Degrees Decimal±Current uncertainty in heading/orientation. A display embodiment can also include LRF=Laser Ranger Finder where LRF GPS Location refers to the GPS coordinates of a target that LRF is being used on. An exemplary embodiment can also show Hu as the horizontal uncertainty in the LRF GPS Location with ‘U’ being the units that ‘XX’ is being measured in. An exemplary embodiment can show Du as a down range uncertainty in the LRF GPS Location with ‘U’ being the units that ‘XX’ is being measured in.

An exemplary embodiment can include calculations capable of deriving a compass heading via an IMU/GPS integrated unit without magnetic calibration and to do so with sufficient accuracy as to be practical to use as a pedestrian carried device.

Although the invention has been described in detail with reference to certain preferred embodiments, variations and modifications exist within the spirit and scope of the invention as described and defined in the following claims.

1. A navigation system, comprising:
an apparatus comprising an inertial navigation unit, a global positioning system, a control system, and a machine readable recording medium storing a plurality of non-transitory machine readable instructions adapted to determine a desired orientation of a sensor at a desired point with respect to the Earth based on determination of orientation of a reference axis of a sensor with respect to locations of multiple points and relationships between the multiple points with a significant degree of accuracy using non-magnetic directional sensing, orientation sensing comprising position determinations via the GPS, orientation data acquired from said inertial navigation unit, and a sequence of measurements along a displaced path including said position determinations and said orientation data.

2. A navigation system as in claim 1, wherein said location includes elevation of the apparatus at each point of said sequence of measurements.

3. A navigation system as in claim 1, wherein said desired orientation of the apparatus at a desired point comprises a first point at which a predetermined accurate orientation value is determined.

4. A navigation system as in claim 3, wherein said desired orientation is true north and said predetermined accuracy is less than five angular mil degrees accuracy.

5. A navigation system as in claim 1, wherein the sequence of measurements can include at least two measurements along a path of travel which is not purely vertical in elevation.
